(19) United States
(12) Patent Application Publication
(10) Pub. No.: US 2018/0259700 A1
(43) Pub. Date: Sep. 13, 2018

(54) BROADBAND DISPERSION-COMPENSATED AND CHIRAL META-HOLOGRAMS

(71) Applicant: PRESIDENT AND FELLOWS OF HARVARD COLLEGE, Cambridge, MA (US)

(72) Inventors: Mohammadreza KHORASANINEJAD, Cambridge, MA (US); Federico CAPASSO, Cambridge, MA (US); Antonio AMBROSIO, Cambridge, MA (US)

(73) Assignee: PRESIDENT AND FELLOWS OF HARVARD COLLEGE, Cambridge, MA (US)

(21) Appl. No.: 15/755,519

(22) PCT Filed: Sep. 1, 2016
(86) PCT No.: PCT/US16/49997

§ 371 Date: Feb. 26, 2018

Related U.S. Application Data
(60) Provisional application No. 62/213,328, filed on Sep. 2, 2015.

(51) Int. Cl. G02B 5/32; G02B 5/18; G02B 1/00

(52) U.S. Cl. CPC G02B 5/32; G02B 13/14; G02B 1/002; G02B 5/1814

(57) ABSTRACT

A device includes a substrate and at least one transmissive directional diffractive component disposed on the substrate. The device has high efficiency transmission over a broadband portion of the electromagnetic spectrum.

### CROSS-REFERENCE TO RELATED PATENT APPLICATIONS

This application claims the benefit of and priority to U.S. Provisional Patent Application 62/213,328 filed Sep. 2, 2015 to Khorasaninejad et al., titled “BROADBAND DISPERSION-COMPENSATED AND CHIRAL META-HOLOGRAMS,” the contents of which are incorporated herein by reference in their entirety.

### STATEMENT REGARDING FEDERALLY SPONSORED RESEARCH OR DEVELOPMENT

This invention was made with Government support under Grant No. FA9550-14-1-0389, awarded by the Air Force Office of Scientific Research (MURI). The Government has certain rights in the invention.

### BACKGROUND

Conventional optical components can be bulky, can be expensive, can have characteristic distortion, or can have low efficiency, among other deficiencies. Such conventional optics may not be practical or feasible for advanced optical systems, or for lightweight or compact optical systems.

### SUMMARY

In an aspect, a device includes at least one transmissive directional diffractive component having high efficiency transmission characteristics over a broadband portion of the electromagnetic spectrum.

In an embodiment, the device further includes a substrate, and one or more of the transmissive directional diffractive component is disposed on the substrate. Each of the transmissive directional diffractive components may include multiple meta-devices. Each meta-device may include multiple dielectric ridge waveguides or nanofins. In an embodiment, two adjacent meta-devices of a first transmissive directional diffractive component are separated from each other and form a first effective aperture. In an embodiment, two adjacent meta-devices of a first transmissive directional diffractive component are separated from each other and form a first effective aperture, two adjacent meta-devices of a second transmissive directional diffractive component are separated from each other and form a second effective aperture, the first effective aperture and the second effective aperture are positioned a distance D apart to introduce a phase difference between light passing through the first and second effective apertures, and the phase difference is proportional to the distance D divided by a wavelength of the light passing through the first and the second effective apertures. A wavelength dependence of diffraction angles of light passing through the first and the second effective apertures compensates for a wavelength dependence of a detour phase. In an embodiment, the device is configured to diffract incident light at a deflection angle relative to a propagation direction of the incident light, where the deflection angle is greater than 0°, such as about 5° or more, about 10° or more, about 15° or more, or about 20° or more.

In an embodiment, a phase map of the device is wavelength-independent.

In an embodiment including dielectric ridge waveguides, a propagation length through each dielectric ridge waveguide, for light at a wavelength of interest, is less than the wavelength of interest. In an embodiment, each of the dielectric ridge waveguides has a width less than a wavelength of electromagnetic energy at a frequency of interest.

The device may be a holographic device, a lens, or a combination of a holographic device and a lens. The device may position a device focus at a desired distance. The device may be incorporated into an optical system to change a focus of the optical system.

In an embodiment, the device is configured to project an image based on a polarization defined by the transmissive directional diffractive component.

The transmissive directional diffractive component may be incorporated into a matrix of transmissive directional diffractive components. A portion of the transmissive directional diffractive components in the matrix may be arranged to form a collimator or a polarization beam splitter. The polarization beam splitter can be either a chiral polarization beam splitter or a linear polarization beam splitter. In an embodiment, a first portion of the transmissive directional diffractive components in the matrix is arranged to form a chiral polarization beam splitter for one handedness of electromagnetic energy, and a second portion of the transmissive directional diffractive components in the matrix is arranged to form a chiral polarization beam splitter for the opposite handedness of electromagnetic energy. The transmissive directional diffractive components in the matrix may be further arranged to form a lens, which, in an embodiment, may be configured to adjust a focal length of the holographic device.

In an embodiment, the device is configured as one of glasses or a visor, with a viewing angle equal to or greater than a natural viewing angle of a human.

In an embodiment, the device is positioned against, in front of, or behind a lens, and is configured to project an image.

In an embodiment, the device is positioned against, in front of, or behind a lens in an optical system, and is configured to change a focus of the optical system.

In an embodiment, the device is positioned against, in front of, or behind a lens, and is configured to provide aberration correction capabilities including correction for spherical aberration, coma, astigmatism, chromatic aberrations, or a combination thereof.

In an embodiment, the device is positioned against, in front of, or behind a lens, and is configured to achieve a functionality of an aspherical lens, to achieve a high numerical aperture greater than or equal to approximately 0.8, or a combination thereof.

The device may be incorporated in a three-dimensional display for glasses or visors.

The device may be positioned against, in front of, or behind a reflector.

### BRIEF DESCRIPTION OF THE DRAWINGS

FIG. 1 illustrates a binary hologram.

FIG. 2A illustrates two pixels of two meta-devices each.

FIG. 2B illustrates results of a simulation of transmitted power of a pixel.

FIG. 2C illustrates results of a simulation of dispersive response of a pixel.

FIG. 2D illustrates pixel overlap.

FIG. 2E is a diagram of a pixel array.

FIG. 3A illustrates a meta-device.

FIG. 3B illustrates results of a simulation of far-field response of a meta-device.

FIG. 3C is a plot of simulation results of deflection angle of a meta-device.

FIG. 3D is a plot of effective index of a meta-device.

FIG. 3E is a plot of phase difference between air and components of a meta-device.

FIG. 4 illustrates a holographic imaging system.

FIG. 5A, FIG. 5B, FIG. 5C and FIG. 5D illustrate intensity distribution for a device illuminated at wavelengths in the near infrared spectrum.

FIG. 5E is a plot of measured efficiency and extinction ratio as functions of wavelength.

FIG. 5F and FIG. 5G compare images taken between two positions of a reconstruction plane two centimeters apart along a light propagation direction.

FIG. 5H, FIG. 5I, FIG. 5J, and FIG. 5K illustrate intensity distribution for a device illuminated at wavelengths in the visible spectrum.

FIG. 6 illustrates a holographic image at a wavelength of 632 nm, where higher diffraction orders than the first are suppressed.

FIG. 7 illustrates simulated far-field response (real (Ey)2) of a meta-device.

FIG. 8 illustrates simulated far-field response (real (Ex)2) of a meta-device.

FIG. 9A and FIG. 9B illustrate a chiral hologram with nanofins.

FIG. 9C, FIG. 9D and FIG. 9E illustrate a chiral hologram with nanofins illuminated with circularly right, circularly left, and linear polarizations, respectively.

FIG. 10A illustrates absolute efficiency as function of wavelength in a chiral holographic device.

FIG. 10B illustrates extinction ratio as function of wavelength in a chiral holographic device.

FIG. 11 illustrates an image in the reconstruction plane for a chiral holographic device when illuminated by left-handed circularly polarized light at different wavelengths.

FIG. 12A and FIG. 12B illustrate examples of display surfaces including meta-devices incorporated with eyewear.

FIG. 13A, FIG. 13B, FIG. 13C, FIG. 13D, FIG. 13E, FIG. 13F, FIG. 13G, FIG. 13H and FIG. 13I illustrate examples of optical systems including subwavelength optical components.

### DETAILED DESCRIPTION

Described in the present disclosure are subwavelength optical components incorporating meta-devices, with an ability to control phase, amplitude, and polarization. The optical components compensate for dispersive wavelength response, and are efficient in both reflection mode and transmission mode configurations. Examples of applications of such optical components include lenses, polarization beam splitters, and holographic imaging or projection, among others.

New capabilities of wavefront molding with planar subwavelength meta-devices are described herein. Associated holographic devices are transmissive, broadband and phase distortion free from near infrared (NIR) wavelengths to visible wavelengths, with high polarization sensitivity, allowing for a wide range of functionalities.

The present disclosure describes the use of transmissive directional diffractive components with high efficiency over a broadband portion of the electromagnetic spectrum. High efficiency refers to at least approximately 10%, such as at least approximately 20%, at least approximately 30%, at least approximately 40%, at least approximately 50%, at least approximately 60%, at least approximately 70%, at least approximately 80%, or at least approximately 90%. Broadband refers to encompassing at least a portion or substantially all of the NIR range (700 nanometers (nm) to 1.4 micrometers (μm)), mid-wavelength infrared (3 μm to 8 μm), far infrared range (15 μm to 1000 μm), the visible range (400 nm to 700 nm), or a combination thereof. For example, the use of transmissive directional diffractive components can provide high efficiency over a range of wavelengths from about 1000 nm to about 1800 nm, from about 1100 nm to about 1800 nm, from about 1000 nm to about 1400 nm, or from about 1100 nm to about 1400 nm.

In one or more embodiments, a device including diffractive components is configured as a holographic device.

In one or more embodiments, a device including diffractive components is configured to position a device focus at a desired distance.

In one or more embodiments, the diffractive components are optically thin. Such optically thin components provide for compact and lightweight optical devices. Additionally, the diffractive components provide an ability to produce images at large angles. These and other features of the diffractive components provide for versatile functionalities such as, for example, use in wearable optics (e.g., three-dimensional displays to be used in glasses for augmented reality), and emerging technologies.

As described in the present disclosure, by revisiting the concept of detour phase, high-performance devices with new functionalities have been designed incorporating metasurfaces. Devices incorporating metasurfaces according to the present disclosure are termed meta-devices herein.

One use of such meta-devices provides for substantially wavelength-independent phase maps, by compensating dispersion of the detour phase with dispersion of subwavelength structures in the meta-device. This leads to broadband operation over a spectrum including visible and NIR light with efficiency as high as 75% in the 1.0 μm to 1.4 μm range. Further, an effective focal length of an imaging optical system can be controlled by incorporating a lens-like function into meta-devices.

Another use of meta-devices provides for a geometric phase incorporated in a phase map to achieve chiral imaging, where the projection of different images depends on a handedness of the reference beam.

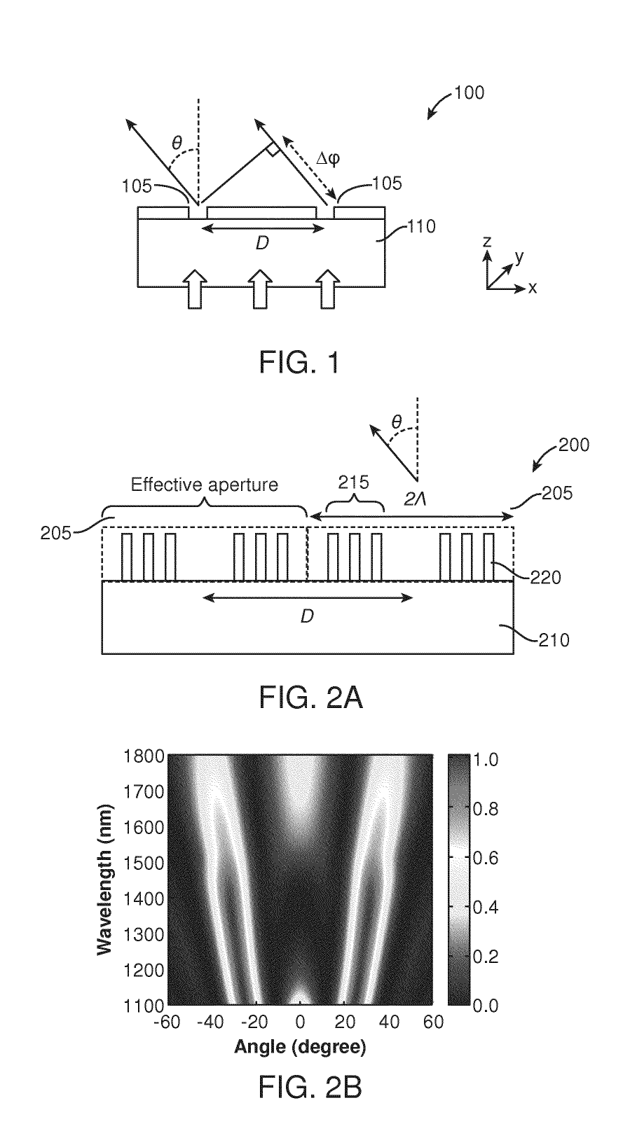

FIG. 1 illustrates a design principle of the holographic devices of the present disclosure based on the detour phase. In FIG. 1, a binary holographic device 100 includes an array of apertures 105 on an opaque screen 110. A detour phase is implemented such that an amplitude and phase are imposed by the apertures 105 on an optical wavefront. For example, a dimension of each aperture 105 sets an amount of light passing through it, and the light is diffracted from two adjacent apertures 105 along a given direction at an angle (θ) from a direction of propagation of the optical wavefront. A phase shift Δφ (detour phase) between light wavelets passing through the two apertures 105 is controlled by adjusting a distance D between the apertures 105. Light wavelets from the two apertures 105 are in phase if the distance D is nλ/sin(θ), where n is an integer and λ is wavelength. For other distances, the light wavelets from the two apertures 105 will be phase-shifted relative to each other by an amount Δφ, as described by Equation (1).

$$Δϕ = \frac{2 π D}{λ} sin ( θ ) \qquad ( 1 )$$

The wavelength dependence of the phase shift in Equation (1) can be suppressed if diffraction from the apertures 105 is designed in such a way as to compensate for intrinsic dispersion. From Equation (1), it can be seen that a dispersionless condition can be achieved if each aperture 105 is replaced with a component having an engineered dispersion similar to that of a grating (for example, sin(θ)˜λ).

In the devices of some embodiments of the present disclosure, apertures (e.g., apertures 105 in FIG. 1) are replaced by subwavelength structured component (meta-device) pixels with a polarization functionality provided by meta-devices forming the pixels. The pixels can be thought of as effective apertures. Note however that, although the description of the pixels as effective apertures is useful for understanding the concepts of the present disclosure, in the devices of some embodiments described in the present disclosure, there is not an opaque screen and there are no apertures.

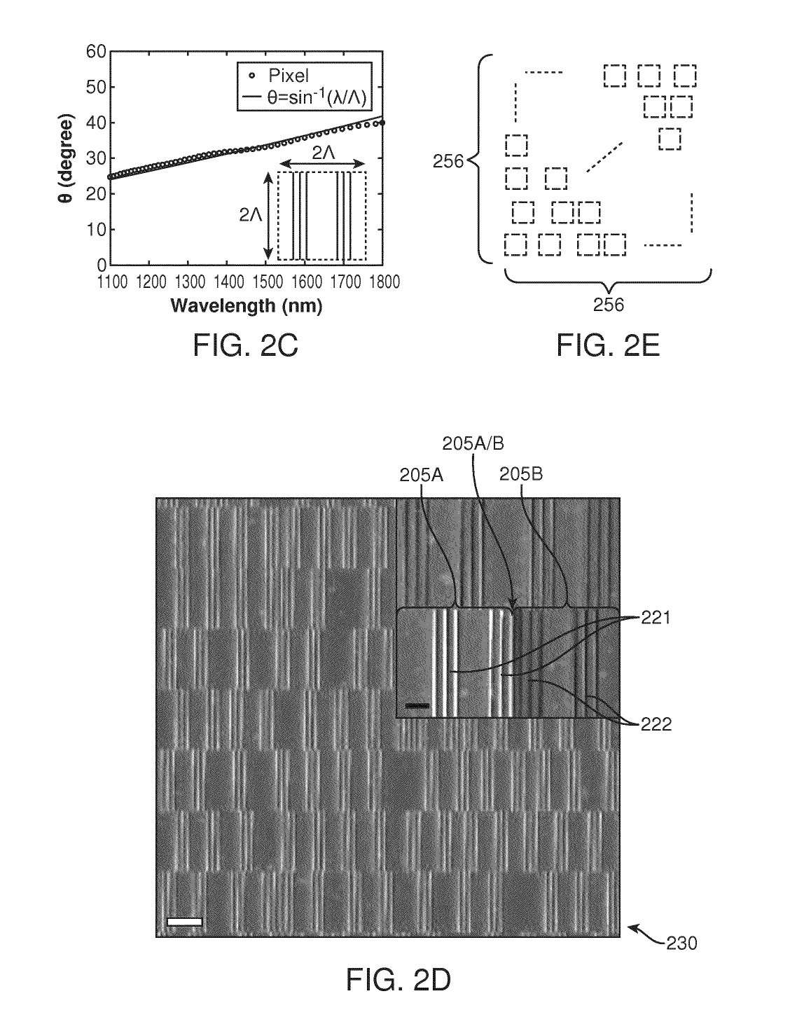

FIG. 2A illustrates an optical device 200 including two or more pixels 205 on a transparent substrate 210 (e.g., glass or transparent silicon). Each pixel 205 of dimension 2A includes two meta-devices 215. Each meta-device 215 includes three nanofins, which are referred to as dielectric ridge waveguides (DRWs) 220 for convenience in the following discussion, although other nanofins may be used instead. There are six DRWs 220 in a pixel (together forming an “effective aperture”). A material of the DRWs 220 may be, for example, amorphous silicon (a-Si).

FIG. 2B shows that transmitted power from each pixel 205 is nearly completely split between the ±1 orders over a broad range of wavelengths (including the range 1100 nm-1800 nm), while other orders are suppressed. The dispersive response of the pixel 205 is designed with finite difference time domain (FDTD) simulations to closely satisfy the relation θ=sin⁻¹(λ/Λ), as illustrated in FIG. 2C, to achieve a substantially wavelength-independent phase shift Δφ as discussed above. Thus, for example, a substantially wavelength-independent phase map for a device incorporating the pixels 205 may have a range of variation of phase shift Δφ over a spectrum of interest that is within about ±15% (e.g., within about ±10%, within about ±5%, within about ±2%, or within about ±1%) of 2πD (see Equation (1)).

A surface of the substrate 210 is structured in pixels 205 displaced with respect to each other to obtain a desired phase map (two such pixels 205 are shown in FIG. 2A). The desired phase distribution that will generate an intensity pattern of interest when illuminated by a reference beam is then computed by means of a Gerchberg-Saxton phase-retrieval technique. The computed phase map is converted into a spatial distribution of displacements D(xₘ, yₘ) that defines an approximate correspondence to a binary phase holographic device (e.g., binary holographic device 100 in FIG. 1). In the devices of some embodiments of the present disclosure, light diffracted by two adjacent pixels 205 is in phase if centers of the pixel 205 are spaced by 2A, (the pixels 205 are touching), as is the case for the illustration in FIG. 2A, which also represents a greatest pixel 205 density without overlap. A desired phase modulation is then achieved by displacing the pixels 205 from the in-phase condition where the pixels 205 are touching. In this manner, a total cross-section of the optical device 200 to the illuminating light is maximized, the spacing between adjacent pixels 205 is minimized, and light that passes through non-diffracted is minimized.

Design of an optical device (e.g., the optical device 200 in FIG. 2A) to achieve a desired phase modulation can result in a physical overlap of a certain number of pixels.

FIG. 2D illustrates an optical device 230 (e.g., an embodiment of the optical device 200 in FIG. 2A) in which the design of the optical device resulted in overlapping pixels 205. For the overlapping pixels 205, the individual DRWs 220 of the overlapping pixels 205 were analyzed. If any of the DRWs 220 overlapped (which was less than 5% of the total number) they were removed, and if none of the DRWs 220 overlapped then the total of twelve DRWs 220 in the two pixels 205 were kept. An example of this latter condition is illustrated in the inset of FIG. 2D, in which pixels 205A, 205B partially overlap by design, but the respective DRWs 221, 222 do not overlap and are kept. Such partial overlap affects an amount of light along the angle θ from those pixels, and results in a possible decrease of a contrast of an image in the Fourier plane (random amplitude modulation). However, a high quality of images obtained shows that this effect is negligible in devices designed according to embodiments of the present disclosure. Phase modulation design as described above allows for a zero to two pi (0-2π) continuous phase variation, and has a high tolerance to fabrication processes.

FIG. 2E illustrates that multiple meta-devices may be formed on a substrate, such as linearly, in a matrix (e.g., as in the 256×256 matrix indicated in FIG. 2E), or in another pattern.

Two studies were performed to show the efficacy of the above approach.

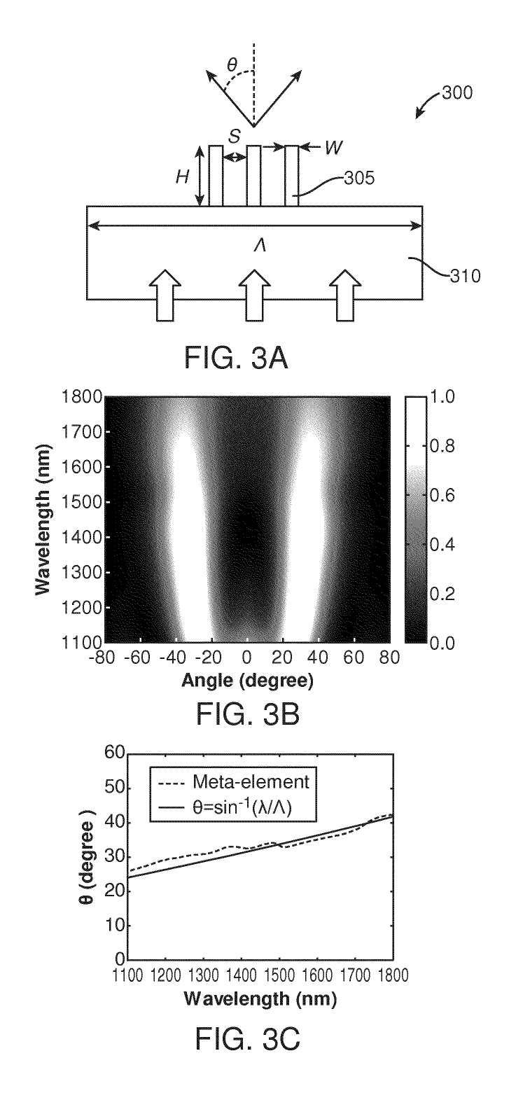

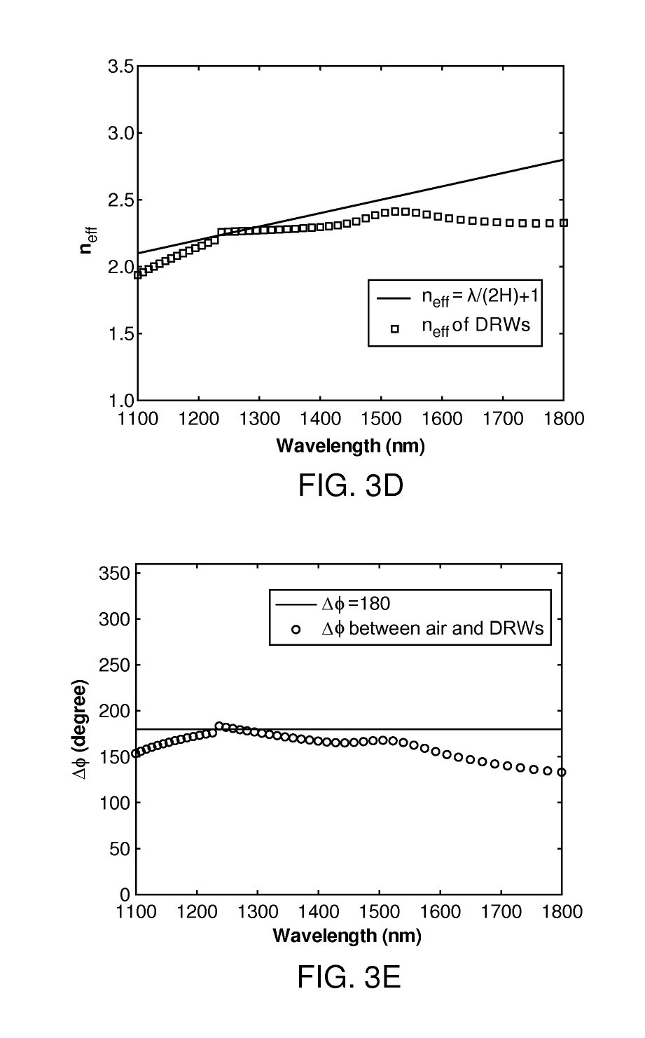

FIG. 3A illustrates a meta-device 300 design according to an embodiment of the present disclosure. For a first study, the meta-device 300 design included three DRWs 305 on a transparent glass substrate 310, where the DRWs were a-Si. The three DRWs 305 were designed to be identical in terms of width (W) and height (H). The DRWs 305 were 120 nm in designed width and 400 nm in designed height, with a designed separation (S) between the DRWs 305 of 380 nm.

FIG. 3B provides 2-dimensional (2D) FDTD simulation results of a far-field (E_{y})² response of the embodiment of the meta-device 300 used in the first study. An FDTD from Lumerical Inc. was used for the simulations. The meta-device 300 was defined as Λ=2700 nm along the x-axis and infinitely long along the y-axis for the study. Incident light polarization was along the y-axis. Engineering the dispersive response of the meta-device 300 resulted in highly directive diffraction in which a majority of the transmitted light was funneled to the first orders while other diffraction orders were suppressed.

FIG. 3C plots the deflection angle for normal incidence of the meta-device 300 embodiment of the first study, calculated from the results shown in FIG. 3B.

It can be seen by the simulation results of FIGS. 3B and 3C that the design of FIG. 3A results in a highly directive meta-device 300 in which the deflection angle follows θ=sin⁻¹(λ/Λ), Λ=2700 nm with good approximation.

FIG. 3D plots target and designed effective index for suppression of forward propagating light of the meta-device 300 embodiment used in the first study, showing that the dispersion relation is achieved with good approximation by the choice of DRWs 305 of the first study.

FIG. 3E plots phase difference between the DRWs 305 and air along the height of the DRWs 305. As shown in FIG. 3E, Δφ is approximately equal to π for the wavelength range 1100 nm-1800 nm.

FIG. 3D and FIG. 3E illustrate that a diffraction condition where a majority of transmitted light is funneled into the first orders (±1) can be achieved by adjusting DRW 305 design parameters (width, height, and separation) and a lateral dimension of the meta-device 300.

Forward scattering is suppressed by choosing parameters (width, height and separation) of the three DRWs 305 so that the phase difference between optical paths along a DRW 305 and the adjacent air is Δφ=π for all design wavelengths. The phase difference is defined by Equation (2), where Δn_{eff}=n_{eff}−1 is the effective refractive index difference between three DRWs 305 and air, and H is a propagation length, equal to the height of the DRWs 305 (e.g., ‘H’ in FIG. 3A).

$$Δϕ = \frac{2 π }{λ} \times Δ {n}_{eff} \times H \qquad ( 2 )$$

Note that the propagation length may in some embodiments be less than the height of the DRWs 305, and in other embodiments may be greater than the height of the DRWs 305.

To fulfill the phase criteria (Δφ=π), the effective index of three DRWs 305 should follow the dispersion relation in Equation (3).

$${n}_{eff} = \frac{λ}{2 H} + 1 \qquad ( 3 )$$

In embodiments other than the particular embodiment of the DRWs 305 of the meta-device 300 of FIG. 3A used in the first study, the DRWs 305 may have different widths, heights, and/or lengths than in the first study, and widths, heights, or lengths may vary between DRWs 305 in the meta-device 300. For example, more generally, a width of each DRW 305 is less than a wavelength of an electromagnetic spectrum of interest, a height of each DRW 305 is less than a wavelength of the electromagnetic spectrum of interest, a width of each DRW 305 is in a range from about 1 nm to about 1000 nm, a height of each DRW 305 is in a range from about 1 nm to about 1000 nm, and a ratio of the length to the width of each DRW 305 is greater than one, such as at least about 1.5:1, at least about 2:1, at least about 3:1, at least about 4:1, or at least about 5:1. Additionally, a number of DRWs 305 and the separation (S) between the DRWs 305 (as well as a separation between groups of DRWs 305) can be determined according to desired characteristics of the meta-device 300.

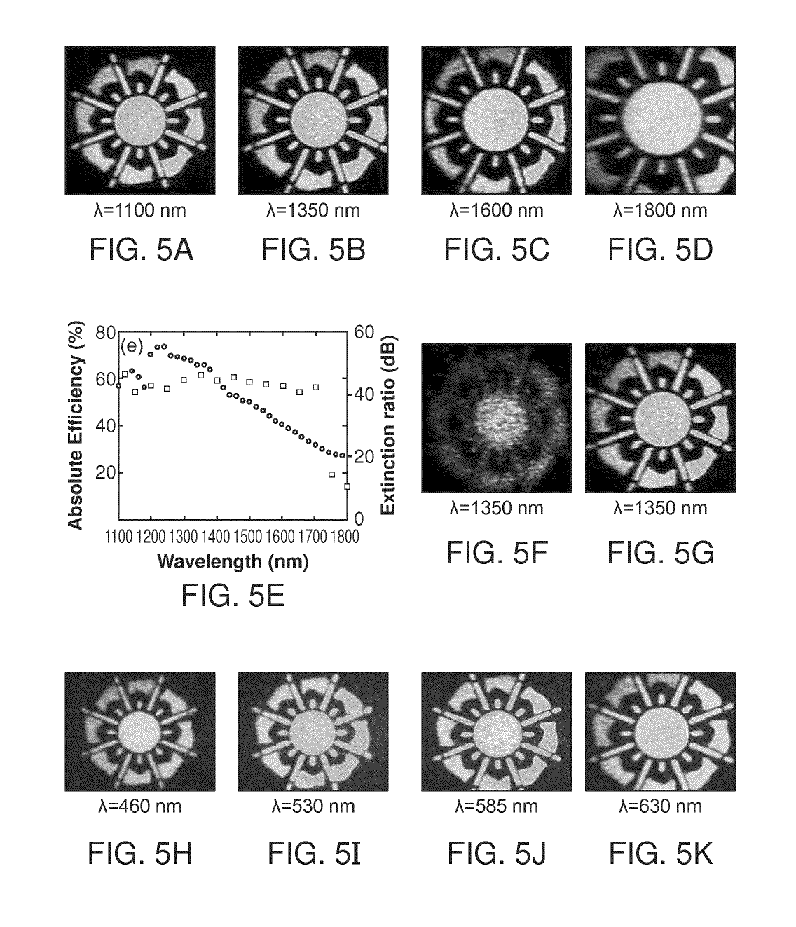

Meta-devices were fabricated according to the design parameters of the embodiment of the meta-device 300 used in the first study. Electron beam lithography (EBL) was used to form the DRWs 305. The EBL (e.g., ELS-F 125) had an ultra-high beam positioning resolution (0.01 nm) that resulted in minimum phase mismatch in the detour phase (see, e.g., FIG. 5E).

Although a-Si has been described with respect to the DRWs 305, other materials may alternatively or additionally be used to fabricate the DRWs 305, and different ones of the DRWs 305 may be of the same or different material(s). In general, the material used for the DRWs 305 is selected to exhibit low loss at a wavelength of interest, with a relatively high refractive index. For example, a refractive index of the material is greater than about 1.5. Examples of suitable DRW 305 materials include, but are not limited to, gallium phosphide, titanium oxide, and silicon nitride, as well as the use of a silicon-on-insulator (SOI) wafer.

Also, while a-Si on a glass substrate has been described herein, which provides for reduced-cost fabrication, other materials are within the scope of the present disclosure. For example, a SOI implementation may be used.

In a second study, a holographic device was made using the pixels such as described with respect to FIG. 2A. A phase shift of light due to diffraction by each aperture along the direction θ, defined relative to the light from a reference aperture propagating along the same direction θ, is provided by Equation (1). Substituting θ=sin⁻¹(λ/Λ) into Equation (1) yields a dispersionless detour phase as shown in Equation (4), where (xₘ, yₘ) are the coordinates of the centers of the pixels, and the index m spans over the total number of pixels.

$$Δϕ ( {x}_{m} , {y}_{m} ) = \frac{2 π D ( {x}_{m} , {y}_{m} )}{Λ} \qquad ( 4 )$$

As an example of device functionality, a far-field intensity distribution corresponding to the 2015 International Year of Light (IYL) logo was designed. FIG. 2D is a scanning electron micrograph (SEM) image of the fabricated holographic optical device 230 (scale is 1 μm). This optical device included a 256×256 matrix of pixels (e.g., as shown in FIG. 2E).

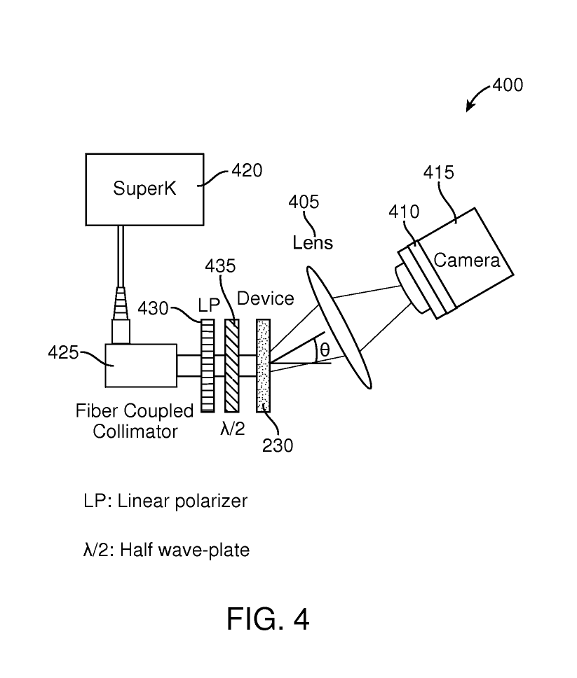

FIG. 4 is a diagram of an experimental setup 400 for image acquisition. A thin lens 405 was used to obtain an image in the Fourier plane where a sensor 410 of an indium gallium arsenide camera 415 (InGaAs camera) was positioned. A laser 420 (“SuperK”) provided a light beam through a fiber coupled collimator 425, a linear polarizer 430, and a half-wave plate 435, and the collimated and linearly polarized light beam was directed to be incident on a surface of the holographic optical device 230.

FIGS. 5A-5D provide images of an intensity distribution generated by the holographic optical device 230 in the Fourier plane under NIR illumination. By design, the hologram has the same image quality for all the wavelengths in the range of λ=1100 nm-1800 nm (image quality may be affected by the measurement setup, such as camera sensitivity and laser source range). This feature results from the dispersionless phase realization approach of Equation (4). Note that the dimension of the images in the reconstruction plane varies with wavelength according to the relation (Nᵢ×λ×f)/Lᵢ where f is the focal length of the lens, Lᵢ is the holographic optical device 230 dimension and Nᵢ is a number of pixels along the x- and y-axes (same number along each axis in this embodiment).

FIG. 5E plots measured efficiency of the holographic optical device 230 as a function of wavelength. The efficiency is defined as a ratio of total intensity of the first diffraction orders to incident intensity. For the efficiency measurements, the intensity was measured by substituting a NIR photodetector (e.g., Thorlabs DET10D) for the InGaAs camera (camera 415 in FIG. 4), where incident intensity was measured as light passing through an aperture (aluminum on a glass) with a same size as the holographic optical device 230. An efficiency as high as approximately 75% was achieved, which is close to the theoretical value of 81% of a binary phase grating optimized for a specific wavelength.

As has been shown, the use of subwavelength diffractive components makes it possible to diffract light with high efficiency, concentrated in the first orders. The wavelength-dependence of the efficiency can be interpreted in terms of an angular distribution of diffracted power. In fact, from the simulation results in FIG. 2B, it can be seen that, for wavelengths between 1150 nm and 1550 nm, most of the light goes to the first orders, with a small (less than 10%) contribution to the zero-order. The peak efficiency at 1250 nm is due to two main contributions: as the wavelength is reduced, the angular response of the first orders narrows (FIG. 2B); and at 1250 nm the designed effective index of the meta-device is closer to the target effective index (FIGS. 3D, 3E).

This reliable phase shift realization provides an opportunity for designing multifunctional devices. To further test the capability of this concept, a Fresnel lens-like function was added to the phase map that corresponds to the holographic optical device 230.

FIGS. 5F, 5G illustrate that the addition of the Fresnel-lens-like phase profile incorporated into the holographic optical device 230 can move the reconstruction plane in the light propagation direction (here, two centimeters forward). Image blurring at a given focal distance (FIG. 5F) is corrected (FIG. 5G) by the Fresnel-lens-like phase profile added to the holographic optical device 230. It is evident that the Fresnel-lens-like function shifted the focal point. It is worth noting that light focusing by the Fresnel-lens-like phase profile of the holographic optical device 230 is occurring along the diffraction direction (θ=30° at λ=1350 nm). Projection at large angles (e.g., θ˜42° at λ=1800 nm) is a long-standing challenge (referred to as the shadow effect) which is overcome by embodiments of devices as described in the present disclosure. Thus, flat and compact optical components for imaging at a wide range of angles may be designed.

FIGS. 5H-5K show that the holographic optical device 230 maintains its functionality even for visible light based on its dispersionless design, although the transmittance of the device drops towards shorter wavelengths due to absorption.

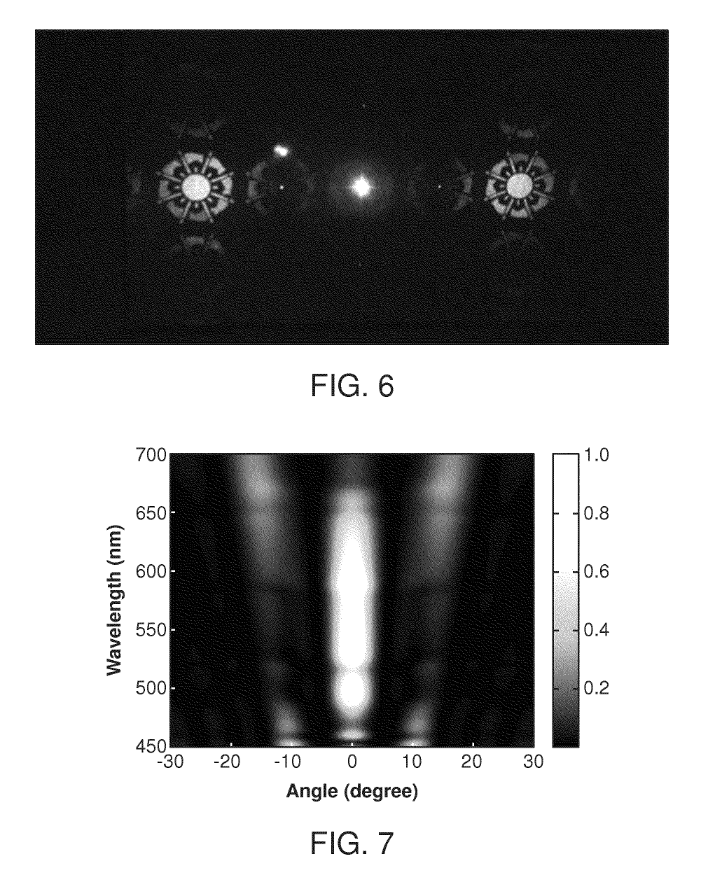

FIG. 6 illustrates the dispersionless functionality of the holographic optical device 230 when illuminated with visible light, where a picture of the IYL logo projected from the holographic optical device 230 on a whiteboard was taken with a digital camera. The main results of the illumination are the field distributions in the ±1 orders. The high intensity of the central spot is due to the non-diffracted light, mostly due to the fact that the beam size (diameter 4 mm) is larger than the device (1.38 mm×1.38 mm). The measurement was performed at 2=632 nm. The power going to the other orders can be explained in terms of the angular distribution of the light scattered from the device.

FIG. 7 illustrates a simulated 2D FDTD far-field response (real (E_{y})²) of a meta-device with three DRWs for the wavelength range 450 nm-700 nm (incident light polarized along y-axis).

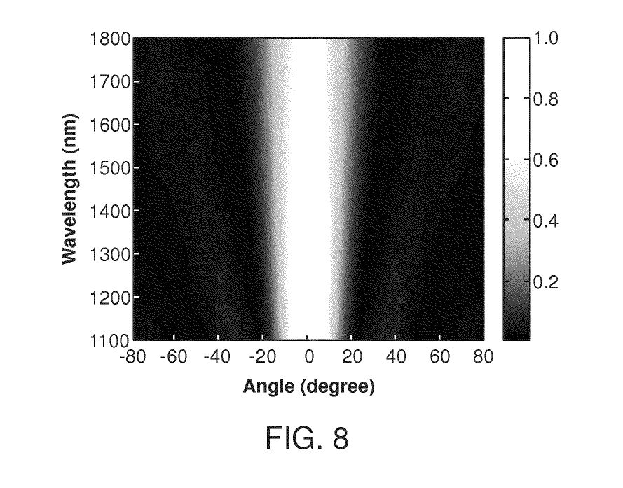

FIG. 8 illustrates a simulated far-field response (real (Eₓ)²) of a meta-device with three DRWs for perpendicular polarization (along x-axis). The meta-device allows this polarization to pass through with minimal deflection. The interaction of the DRWs (e.g., DRWs 220) with the incident light is polarization dependent due to the DRWs deep-subwavelength width and asymmetric cross-section (the length is much greater than the width). In other words, light linearly polarized along the length of the DRWs (y-axis) is efficiently diffracted while light polarized along the width (x-axis) is transmitted nearly non-diffracted. Due to the polarization sensitivity of each pixel, the device is characterized by a high extinction ratio (ER) between orthogonal polarizations, within a broad wavelength range (FIG. 5E). ER is defined as the ratio of normalized intensities in the images for two different polarizations (along the y- and x-axes for the IYL hologram, or circularly left- and right-polarized for a chiral hologram discussed below).

As further proof of the versatility of the concepts of the present disclosure, a chiral holographic device was designed whose functionality depends on a handedness of a reference beam.

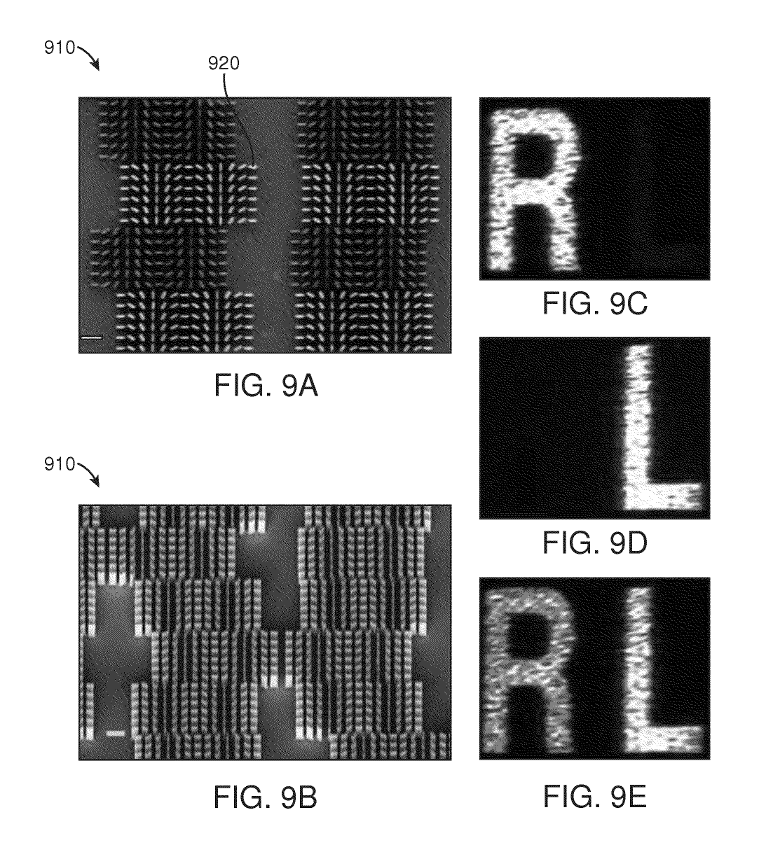

FIGS. 9A, 9B illustrate portions of a chiral holographic device 910 from top and angled views, respectively (scale is 1 μm). The chiral holographic device 910 includes meta-devices with nanofins 920. When circularly polarized light passes through the nanofins 920, the light is diffracted along a principal direction (θ) according to its handedness. Changing the light handedness results in switching of the direction from θ to −θ. In the fabricated device, each pixel was divided in two parts (along the y-axis direction), where one part was coupled to one handedness while the other part was coupled to the opposite handedness. Note that the rotated nanofins in the design introduce a geometrical phase similar to the Berry-Pancharatman phase. In this way, an image displayed in a field of view of chiral holographic device 910 depends on the light handedness.

FIGS. 9C-9E show that a light intensity distribution corresponding to the letter “R” appears (FIG. 9C) under right-circularly polarized illumination while it changes into the letter “L” (FIG. 9D) for left-circular polarization. In this case a quarter wave-plate is used (e.g., in the setup of FIG. 4) to generate the circular polarization. For linear polarization, both letters appear (FIG. 9E).

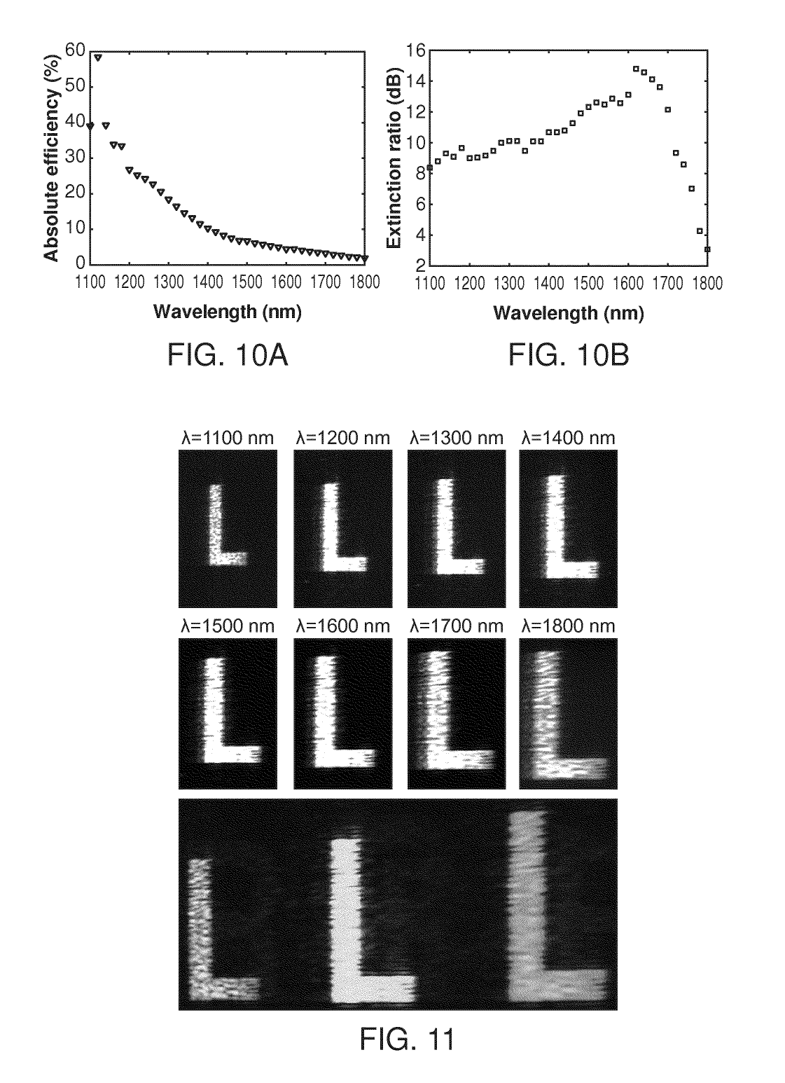

FIG. 10A illustrates that the chiral holographic device 910 has high values of absolute efficiency over a broadband range.

FIG. 10B illustrates that the chiral holographic device 910 has high ER as well as a broadband functionality.

A 3-dimensional (3D) simulation was used for the simulations in FIGS. 10A, 10B.

FIG. 11 illustrates an image in the reconstruction plane for chiral holographic device 910 when illuminated by left-handed circularly polarized light at different wavelengths. For the NIR region, the wavelengths are indicated on top of the images. For visible wavelengths, the three images along the bottom correspond to the wavelengths: 480 nm (left), 550 nm (center) and 635 nm (right).

An electron beam lithography system with ultra-high beam positioning resolution (0.01 nm) was used to fabricate meta-devices such as the ones described above with respect to embodiments of the present disclosure, helping to minimize phase mismatch in the detour phase. Alternative fabrication methods such as deep ultraviolet lithography and nano-imprinting can facilitate the mass production of devices according to embodiments of the present disclosure.

The phase distributions encoded as detour phase in the devices described in this disclosure were computed using the Gerchberg-Saxton phase-retrieval technique with Fast Fourier Transform functions. Other techniques may be used instead. A phase-only hologram was implemented, such that the amplitude of the complex two-dimensional distribution provided by the technique was discarded.

The detour phase allows a continuous variation of the phase modulation between 0 and 2π, as opposed to spatially discrete recording/display systems where phase-nonlinearities result in mismatch with respect to the designed modulation.

Some embodiments have been described above by way of example, and other devices are also within the scope of the present disclosure. A few additional examples follow. One or more devices according to embodiments of the present disclosure may be used alone or in combination to correct for spherical aberration, coma, astigmatism, chromatic aberrations, or a combination thereof. In one or more embodiments, one or more devices according to embodiments of the present disclosure may be used alone or in combination in an optical system (e.g., positioned against, in front of, or behind a lens) to correct for spherical aberration, coma, astigmatism, chromatic aberrations, or a combination thereof of the optical system. A device according to an embodiment of the present disclosure may be configured to achieve a functionality of an aspherical lens. Such a device may be, for example, positioned against, in front of, or behind another lens. A device according to an embodiment of the present disclosure may be configured to achieve a high numerical aperture greater than or equal to approximately 0.8. Such a device may be, for example, positioned against, in front of, or behind another lens. A device according to an embodiment of the present disclosure may be positioned against, in front of, or behind a reflector.

As has been described, meta-devices can be used to build phased pixels in flat and compact holographic devices with a broadband response. Depending on the subwavelength structured building block, different responses to light polarization states can be encoded for scalable polarimetric devices. Furthermore, lens-like optical elements working off-axis can be implemented for wearable devices where lightness, compactness and image quality are desirable. Optical functionality such as imaging at an angle can be achieved with thin, small, lightweight and efficient diffractive components including meta-devices fabricated on a transparent substrate, which can be integrated into near-to-eye displays and wearable optical systems. In addition, a new hologram with chiral imaging functionality has been demonstrated. Additionally, using dielectric materials instead of metals allows one to work in a transmission scheme with a transparent substrate while minimizing optical losses.

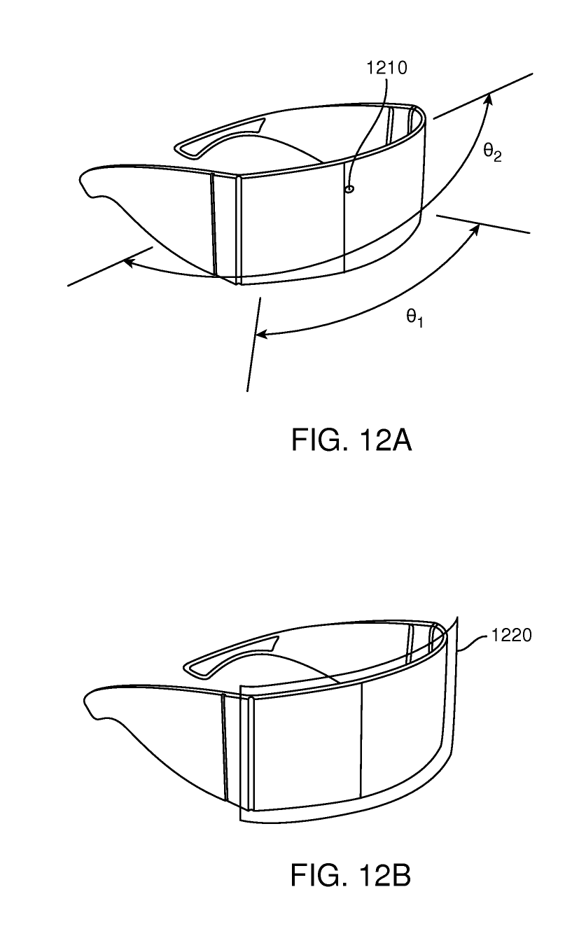

FIG. 12A and FIG. 12B illustrate examples of wearable devices in a form of eyewear, such as eyeglasses, goggles, three-dimensional goggles, or other eyewear.

In FIG. 12A, a display area 1210 of the eyewear includes meta-devices as described with respect to various embodiments of the present disclosure, the meta-devices arranged to provide a desired functionality such as any of the functionalities described above (e.g., holographic function, correction for spherical aberration, coma, astigmatism, chromatic aberrations, or a combination thereof, adjustment for focal length, or a combination thereof). In one or more embodiments, a natural viewing angle of a human (on average) is θ₁, and the display area 1210 of the eyewear provides a viewing angle of θ₂ which is greater than θ₁.

In FIG. 12B, a display area 1220 is provided as an attachment to eyewear. Although shown as an attachment at an outside of the eyewear, the display area 1220 may alternatively be attached at an inside of the eyewear. Further, a first display area 1220 may be attached at an outside of the eyewear, and a second display area 1220 may be attached at an inside of the eyewear, where the first display area 1220 and the second display area 1220 may provide different functionalities (e.g., holographic function, correction for spherical aberration, coma, astigmatism, chromatic aberrations, or a combination thereof, adjustment for focal length, or a combination thereof). Similarly, one or more display areas 1220 may be attached at an inside or an outside of the eyewear depicted in FIG. 12A, to augment functionality of the display area 1210.

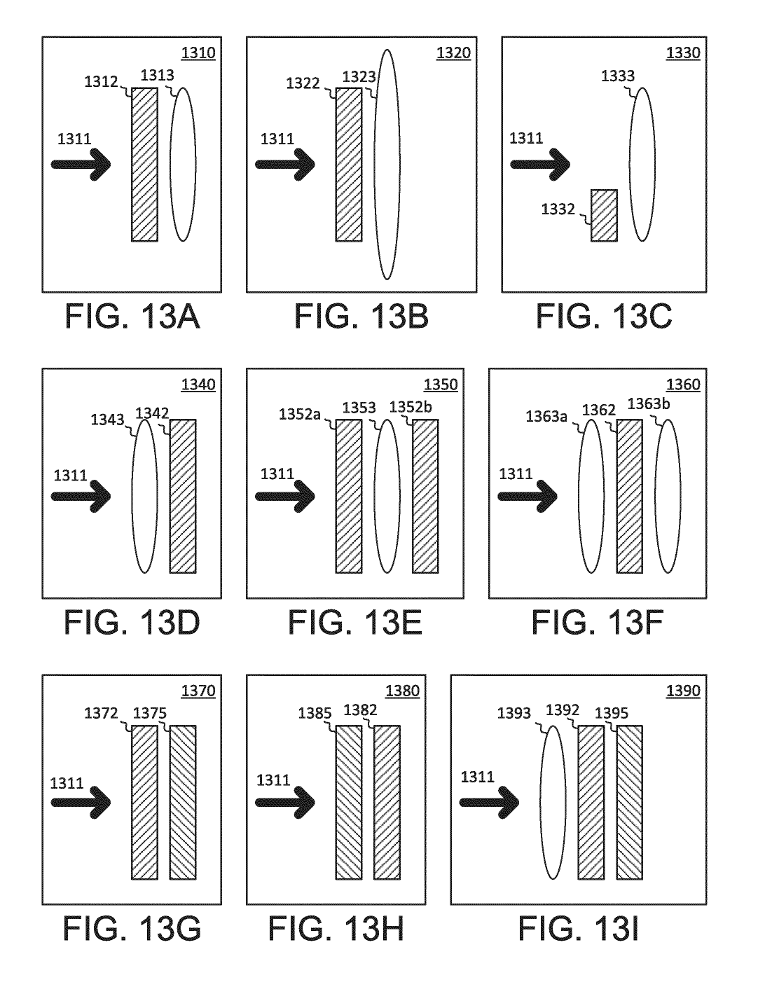

FIGS. 13A-13I depict examples of portions of optical systems incorporating optical devices according to embodiments of the present disclosure. In each of FIGS. 13A-13I, a direction of incident light is indicated by an arrow 1311.

In FIG. 13A, an optical system 1310 includes an optical device 1312 and a lens 1313. The optical device 1312 includes meta-devices, and the optical device 1312 is designed to provide one or more functionalities such as described in the present disclosure. In this example, the optical device 1312 is positioned in front of the lens 1313 (with respect to the direction of incident light). The optical device 1312 may be at a distance from the lens 1313, or may be positioned against the lens 1313 to contact the lens 1313. Also in this embodiment, the optical device 1312 and the lens 1323 have similar dimensions (e.g., diameter).

In FIG. 13B, an optical system 1320 includes an optical device 1322 and a lens 1323. The optical device 1322 includes meta-devices, and the optical device 1322 is designed to provide one or more functionalities such as described in the present disclosure. In this example, the optical device 1322 is positioned in front of the lens 1313 (with respect to the direction of incident light). The optical device 1322 may be at a distance from the lens 1323, or may be positioned against the lens 1323 to contact the lens 1323. Also in this embodiment, the optical device 1312 has a different (lesser) dimension (e.g., diameter) than the lens 1323.

In FIG. 13C, an optical system 1330 includes an optical device 1332 and a lens 1333. The optical device 1332 includes meta-devices, and the optical device 1332 is designed to provide one or more functionalities such as described in the present disclosure. In this example, the optical device 1332 is positioned in front of the lens 1333 (with respect to the direction of incident light). The optical device 1332 may be at a distance from the lens 1333, or may be positioned against the lens 1333 to contact the lens 1333. Also in this embodiment, the optical device 1332 has a much smaller dimension (e.g., diameter) than the lens 1333, such as to correct functionality of a portion of the lens 1333.

In FIG. 13D, an optical system 1340 includes an optical device 1342 and a lens 1343. The optical device 1342 includes meta-devices, and the optical device 1342 is designed to provide one or more functionalities such as described in the present disclosure. In this example, the optical device 1342 is positioned behind the lens 1343 (with respect to the direction of incident light). The optical device 1342 may be at a distance from the lens 1343, or may be positioned against the lens 1343 to contact the lens 1343. Also in this embodiment, the optical device 1342 and the lens 1343 have similar dimensions (e.g., diameter), although the relative dimensions may instead be different.

In FIG. 13E, an optical system 1350 includes optical devices 1352a, 1352b and a lens 1353. The optical devices 1352a, 1352b each includes meta-devices, and the optical devices 1352a, 1352b each is designed to provide one or more functionalities such as described in the present disclosure. In this example, the lens 1353 is positioned between the optical devices 1352a, 1352b. The lens 1352 may be at distance from one or both optical devices 1352a, 1352b or may be positioned against one or both optical devices 1352a, 1352b. Also in this embodiment, the optical devices 1352a, 1352b and the lens 1343 have similar dimensions (e.g., diameter), although the relative dimensions may instead be different.

In FIG. 13F, an optical system 1360 includes an optical device 1362 and lenses 1363a, 1363b. The optical device 1362 includes meta-devices, and the optical device 1362 is designed to provide one or more functionalities such as described in the present disclosure. In this example, the optical device 1362 is positioned between the lenses 1363a, 1363b. The optical device 1362 may be at distance from one or both lenses 1363a, 1363b or may be positioned against one or both lenses 1363a, 1363b. Also in this embodiment, the optical device 1362 and the lenses 1363a, 1363b have similar dimensions (e.g., diameter), although the relative dimensions may instead be different.

In FIG. 13G, an optical system 1370 includes an optical device 1372 and a reflector 1375. The optical device 1372 includes meta-devices, and the optical device 1372 is designed to provide one or more functionalities such as described in the present disclosure. In this example, the optical device 1372 is positioned in front of the reflector 1375 (with respect to the direction of incident light). The optical device 1372 may be at a distance from the reflector 1375, or may be positioned against the reflector 1375 to contact the reflector 1375. Also in this embodiment, the optical device 1372 and the reflector 1375 have similar dimensions (e.g., diameter), although the relative dimensions may instead be different.

In FIG. 13H, an optical system 1380 includes an optical device 1382 and a reflector 1385. The optical device 1382 includes meta-devices, and the optical device 1382 is designed to provide one or more functionalities such as described in the present disclosure. In this example, the optical device 1382 is positioned behind the reflector 1385 (with respect to the direction of incident light). The optical device 1382 may be at a distance from the reflector 1385, or may be positioned against the reflector 1385 to contact the reflector 1385. Also in this embodiment, the optical device 1382 and the reflector 1385 have similar dimensions (e.g., diameter), although the relative dimensions may instead be different.

In FIG. 13I, an optical system 1390 includes an optical device 1392, a lens 1393, and a reflector 1395, illustrating that multiple components may be combined with one or more optical devices such as optical device 1392. The optical device 1392 includes meta-devices, and the optical device 1392 is designed to provide one or more functionalities such as described in the present disclosure.

Some configurations of optical systems are presented by way of example in FIGS. 13A-13I. Other configurations are also within the scope of the present disclosure.

Spatial descriptions, such as “above,” “below,” “up,” “left,” “right,” “down,” “top,” “bottom,” “vertical,” “horizontal,” “side,” “higher,” “lower,” “upper,” “over,” “under,” and so forth, are indicated with respect to the orientation shown in the figures unless otherwise specified. It should be understood that the spatial descriptions used herein are for purposes of illustration only, and that practical implementations of the structures described herein can be spatially arranged in any orientation or manner, provided that the merits of embodiments of this disclosure are not deviated by such arrangement.

As used herein, the terms “approximately,” “substantially,” “substantial” and “about” are used to describe and account for small variations. When used in conjunction with an event or circumstance, the terms can refer to instances in which the event or circumstance occurs precisely as well as instances in which the event or circumstance occurs to a close approximation. For example, when used in conjunction with a numerical value, the terms can refer to a range of variation less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, two numerical values can be deemed to be “substantially” the same if a difference between the values is less than or equal to ±10% of an average of the values, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified.

While the disclosure has been described with reference to the specific embodiments thereof, it should be understood by those skilled in the art that various changes may be made and equivalents may be substituted without departing from the true spirit and scope of the disclosure. In addition, many modifications may be made to adapt a particular situation, material, composition of matter, method, operation or operations, to the objective, spirit and scope of the disclosure. All such modifications are intended to be within the scope. In particular, while certain methods may have been described with reference to particular operations performed in a particular order, it will be understood that these operations may be combined, sub-divided, or re-ordered to form an equivalent method without departing from the teachings of the disclosure. Accordingly, unless specifically indicated herein, the order and grouping of the operations is not a limitation of the disclosure.

What is claimed is:

1. A device, comprising:
a substrate; and
at least one transmissive directional diffractive component disposed on the substrate, wherein the device has high efficiency transmission over a broadband portion of the electromagnetic spectrum.

2. The device of claim 1, wherein each of the at least one transmissive directional diffractive components disposed on the substrate comprises a plurality of meta-devices.

3. The device of claim 2, wherein each meta-device comprises a plurality of dielectric ridge waveguides, and two adjacent meta-devices of a first transmissive directional diffractive component are separated from each other and form a first effective aperture.

4. The device of claim 3, wherein two adjacent meta-devices of a second transmissive directional diffractive component are separated from each other and form a second effective aperture, the first effective aperture and the second effective aperture are positioned a distance D apart to introduce a phase difference between light passing through the first and second effective apertures, and the phase difference is proportional to the distance D divided by a wavelength of the light passing through the first and the second effective apertures.

5. The device of claim 4, wherein a wavelength dependence of diffraction angles of light passing through the first and the second effective apertures compensates a wavelength dependence of a detour phase.

6. The device of claim 5, wherein a phase map of the device is substantially wavelength-independent.

7. The device of claim 3, wherein a propagation length through each dielectric ridge waveguide, for light at a wavelength of interest, is less than the wavelength of interest.

8. The device of claim 3, wherein each of the dielectric ridge waveguides has a width less than a wavelength of electromagnetic energy at a frequency of interest.

9. The device of claim 1, configured as a holographic device.

10. The device of claim 1, configured as a lens.

11. The device of claim 10, further configured as a holographic device.

12. The device of claim 10, configured to position a device focus at a desired distance.

13. The device of claim 10, wherein the device is incorporated into an optical system and is configured to change a focus of the optical system.

14. The device of claim 1, wherein the device is configured to project an image based on a polarization defined by the at least one transmissive directional diffractive component.

15. The device of claim 1, wherein the at least one transmissive directional diffractive component is a matrix of transmissive directional diffractive components.

16. The device of claim 15, wherein a portion of the transmissive directional diffractive components in the matrix are arranged to form a collimator.

17. The device of claim 15, wherein a portion of the transmissive directional diffractive components in the matrix are arranged to form a polarization beam splitter.

18. The device of claim 17, wherein the polarization beam splitter is a chiral polarization beam splitter or a linear polarization beam splitter.

19. The device of claim 18, wherein a first portion of the transmissive directional diffractive components in the matrix is arranged to form a chiral polarization beam splitter for one handedness of electromagnetic energy, and a second portion of the transmissive directional diffractive components in the matrix is arranged to form a chiral polarization beam splitter for the opposite handedness of electromagnetic energy.

20. The device of claim 19, wherein the transmissive directional diffractive components in the matrix are further arranged to form a lens.

21. The device of claim 20, configured as a holographic device, wherein the lens is configured to adjust a focal length of the holographic device.

22. An eyeglass or a visor comprising the device of claim 1, configured with a viewing angle equal to or greater than a natural viewing angle of a human.

23. A three-dimensional display for an eyeglass or a visor, the display comprising the device of claim 1.

24. An optical system, comprising:
a lens; and
the device of claim 1, positioned against, in front of, or behind the lens.

25. The optical system of claim 24, wherein the device is configured to project an image.

26. The optical system of claim 24, wherein the device is configured to change a focus of the optical system.

27. The optical system of claim 24, wherein the device is configured to provide aberration correction capabilities including correction for spherical aberration, coma, astigmatism, chromatic aberrations, or a combination thereof.

28. The optical system of claim 24, wherein the device is configured to achieve a functionality of an aspherical lens.

29. The optical system of claim 24, wherein the device is configured to achieve a high numerical aperture greater than or equal to 0.8.

30. An optical system, comprising:
a reflector; and
the device of claim 1, positioned against, in front of, or behind the reflector.
